(19) United States
(12) Patent Application Publication
(10) Pub. No.: US 2006/0055548 A1
(43) Pub. Date: Mar. 16, 2006

(54) Smoke detecting system having self-monitoring function

(76) Inventor: Ki Deog Kong, Kyunggi-do (KR)

Correspondence Address: BACHMAN & LAPOINTE, P.C., 900 CHAPEL STREET, SUITE 1201, NEW HAVEN, CT, 06510, US

(21) Appl. No.: 10/940,292

(22) Filed: Sep. 13, 2004

(51) Int. Cl. G08B 17/10; G08B 1/08; G08B 21/00

(52) U.S. Cl. 340/628; 340/533; 340/635; 340/650; 340/652; 340/653

(57) ABSTRACT

There is provided a smoke detecting system having self-monitoring function in which working status of a smoke detector, non-polarized wire cables and a signal receiving station are self-tested. The smoke detecting system comprises a smoke detector which detects the presence of a smoke accompanied with a fire, a signal receiving station which generates an alert signal, non-polarized wire cables which physically connect the smoke detector to the signal receiving station, and a detector circuitry which monitors the working status of the smoke detector, the signal receiving station and the non-polarized wire cables, wherein the detector circuitry is branched at a middle of one of the non-polarized wire cables. There is no change in the internal circuitry of the smoke detector. And, the working status of the smoke detecting system can be monitored by visual inspection.

### TECHNICAL FIELD OF THE INVENTION

The present invention relates to a smoke detecting system having self-monitoring function. More specifically, the present invention relates to a smoke detecting system having self-monitoring function in which working status of a smoke detector, non-polarized wire cables and a signal receiving station are self-tested.

### BACKGROUND OF THE INVENTION

Fire detecting systems are generally classified into two categories: a system which detects a smoke accompanied with a fire; and a system which detects a heat emitted from a fire. The heat detecting system includes a fixed temperature type heat detecting system in which an internal bimetal expands and connects to a contact point if the temperature of the surroundings is reached to a predetermined value, and a differential type heat detecting system in which expansion of an air accompanied with sudden rise of the temperature of the surroundings pushes up a lamp disposed within a heat detecting chamber and connects to a contact point. Such a heat detecting system has an advantage of minimized intervention from an installation environment. However, the heat detecting system suffers from a narrow detection range and a late detection time. In addition, the heat detecting system does not generate an alarm signal when low heat is emitted. Therefore, the heat detecting system can not fully satisfy early extinguishment of a fire. Sometimes, a late fire alert signal may threaten the life of human beings.

The smoke detecting system has advantages of a wide detection range and a fast detection time. For these reasons, the smoke detecting system is popularly used in office buildings. Further, in the place where a communication infrastructure or a power supply is installed, the smoke detecting system is essentially installed. The smoke detecting system senses scattered light from smoke particles introduced into a room. Referring to FIG. 1, the principle of the smoke detecting system will be more fully illustrated. A smoke detector 2 works with aid of a power supplied from a signal receiving station 1. When a smoke is introduced into a room, a light emitting diode (LED) (not shown) of the smoke detector 2 blinks and a relay of the signal receiving station 1 receives the fire breaking out signal from a resistance loop of an internal circuitry of the smoke detector 2 and generates an alert signal. Unexplained reference numeral 3 is non-polarized wire cables. However, the smoke detecting system suffers from a disadvantage that working status of the signal receiving station 1, the smoke detector 2, and the non-polarized wire cables 3 should be carefully examined. It should be regularly checked whether the signal receiving station 1, the smoke detector 2, and/or the non-polarized wire cables 3 are working well or in an abnormal working status.

Conventionally, an artificial spray of a smoke to the smoke detector 2 has been performed in order to check whether the smoke detecting system works well or not. During repeated artificial sprays of the smoke, foreign materials are sometimes coated onto components of the smoke detector 2. This may significantly reduce detection sensitivity of the smoke detector 2.

In order to avoid such a problem, Korean utility model No. 256,311 discloses a smoke detecting system in which a resonance part and a laminating part are installed at an internal circuitry of the smoke detector in order to monitor the working status of the system. Korean utility model No. 210,753 discloses a smoke detecting system comprising a non-polarized bridge circuitry, an oscillatory circuitry, and an IR emitting circuitry, a receiving circuitry, and a signal comparative circuitry, a working circuitry, wherein a working detection diode is connected in series between a transistor and an diode of the IR emitting circuitry. However, the Korean utility model Nos. 210,753 and 256,311 suffered from the disadvantage that the internal circuitry of the smoke detector should be changed in order to check the working status of the smoke detector, the non-polarized wire cables and the signal receiving station. Further, it should be kept in mind that the current used for the monitoring of the working status of the system is as low as 50 μA. Such a low detection current may be affected by an induced current within the internal circuitry of the smoke detector such that the erroneous check can be made even though the system is in an abnormal condition.

### SUMMARY OF THE INVENTION

An object of the present invention is to provide a smoke detecting system in which the working status of a smoke detector, non-polarized wire cables and a signal receiving station are self-tested. In other words, there is provide a smoke detecting system having a self-monitoring function which can avoids the problem of the conventional smoke detecting systems.

Another object of the present invention is to provide a smoke detecting system in which the working status of the system can be monitored through visual inspection.

Further another object of the present invention is to provide a smoke detecting system which monitors the working status of a smoke detector, non-polarized wire cables and a signal receiving station without any change of an internal circuitry of the smoke detector.

According to the preferred embodiment of the present invention, there is provided a smoke detecting system in which a detector circuitry is branched at a middle of one of the non-polarized wire cables. The detector circuitry is not disposed inside the internal circuitry of the smoke detector. There is no change to the internal circuitry of the smoke detector.

According to another preferred embodiment of the present invention, there is provided a smoke detecting system comprising a smoke detector, a signal receiving station, non-polarized wire cables which physically connect the smoke detector to the signal receiving station, and a detector circuitry which monitors working status of the smoke detector, the signal receiving station and non-polarized wire cables, wherein the detector circuitry is branched at a middle of one of the non-polarized wire cables.

According to further another preferred embodiment of present invention, there is a smoke detecting system which comprises:
a smoke detector which detects the presence of a smoke accompanied with a fire;
a signal receiving station which generates an alert signal;
non-polarized wire cables which physically connect the smoke detector to the signal receiving station; and
a detector circuitry which monitors the working status of the smoke detector, the signal receiving station and the non-polarized wire cables,
wherein the detector circuitry is branched at a middle of one of the non-polarized wire cables.

According to more preferred embodiment of present invention, there is a smoke detecting system which comprises:
a smoke detector which detects the presence of a smoke accompanied with a fire;
a signal receiving station which generates an alert signal;
non-polarized wire cables which physically connect the smoke detector to the signal receiving station; and
a detector circuitry which monitors the working status of the smoke detector, the signal receiving station and the non-polarized wire cables,
wherein the detector circuitry comprises a current detecting terminal branched at a middle of one of the non-polarized wire cables, a coupler coupled to the signal detecting terminal which senses a minute current flowing along the signal detecting terminal, and a display circuitry coupled to the coupler which comprises a transistor amplifying the sensed current and a light emitting diode indicating the working status of the smoke detector, the signal receiving station and the non-polarized wire cables.

According to more preferred embodiment of present invention, there is a smoke detecting system which comprises:
a smoke detector which detects the presence of a smoke accompanied with a fire;
a signal receiving station which generates an alert signal;
non-polarized wire cables which physically connect the smoke detector to the signal receiving station;
a detector circuitry which monitors the working status of the smoke detector, the signal receiving station and the non-polarized wire cables, comprising a current detecting terminal branched at a middle of one of the non-polarized wire cables, a coupler coupled to the signal detecting terminal which senses a minute current flowing along the signal detecting terminal, and a display circuitry coupled to the coupler which comprises a transistor amplifying the sensed current and a light emitting diode indicating the working status of the smoke detector, the signal receiving station and the non-polarized wire cables; and
a power supply circuitry coupled to the detector circuitry which supplies a power to the detector circuitry and which comprises a power terminal, a constant voltage supply circuitry and a light emitting diode which indicates working status of the power supply introduced to the detector circuitry.

### BRIEF DESCRIPTION OF THE DRAWINGS

FIG. 1 is a block diagram showing an outline of the conventional smoke detecting system.

FIG. 2 is a diagram showing the preferred embodiment of the smoke detecting system in accordance with the present invention.

FIG. 3 is a perspective view showing a specific example of the smoke detecting system in accordance with the present invention.

FIG. 4 is a perspective view showing another specific example of the smoke detecting system in accordance with the present invention.

### DETAILED DESCRIPTION OF THE INVENTION

Referring to accompanying drawings, the present invention will be more fully illustrated.

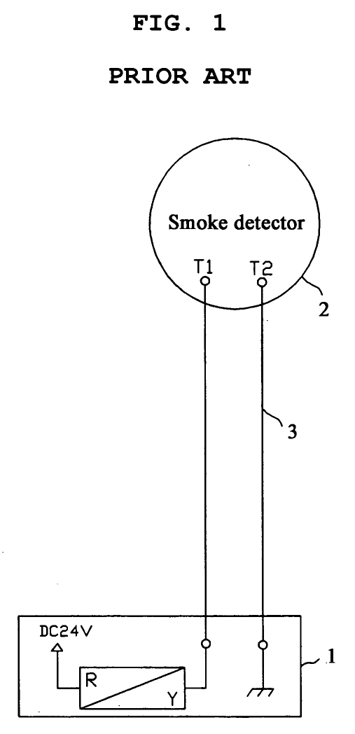

FIG. 1 is a block diagram showing an outline of the conventional smoke detecting system. As shown in FIG. 1, the system comprises a signal receiving station 1, a smoke detector 2 and non-polarized connection cables 3. A power to work the smoke detector 2 is supplied from the signal receiving station 1 through the non-polarized connection cables 3. When a power applies to T1 and T2 terminals, the smoke detector 2 works and a sensing part (not shown) disposed within the smoke detector 2 senses the presence of a smoke. When the presence of a smoke is detected, a light emitting diode (not shown) of the smoke detector 2 is blinking. At the same time, a resistive load is applied to between T1 and T2 terminals of the smoke detector 2, and this produces a working current of a relay of the signal receiving station 1 and generates a fire alert signal.

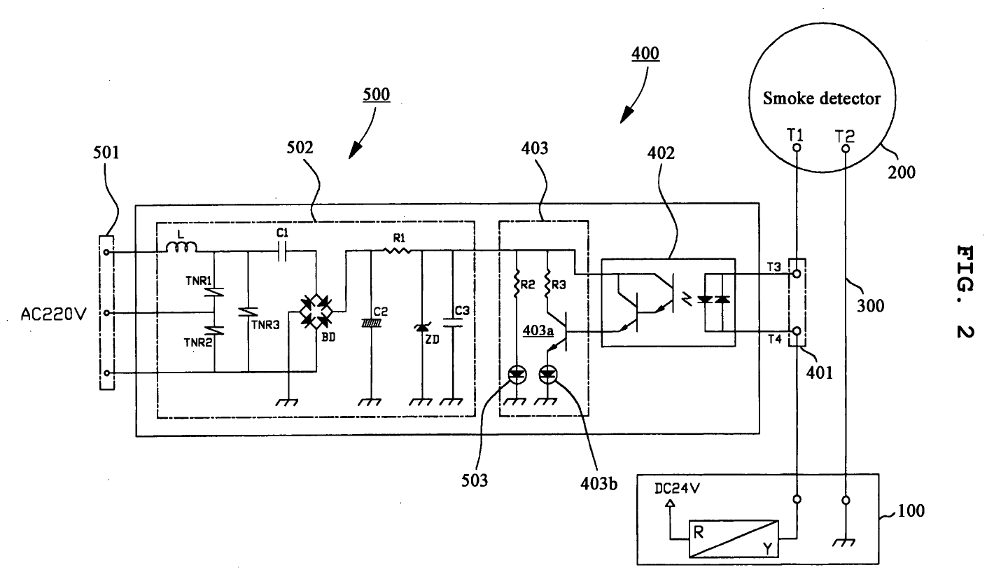

FIG. 2 is a diagram showing the preferred embodiment of the smoke detecting system in accordance with the present invention. As shown in FIG. 2, the smoke detecting system according to the present invention comprises a smoke detector 200, a signal receiving station 100, non-polarized wire cables 300 and a detector circuitry 400. The smoke detector 200 detects the presence of a smoke accompanied with a fire. When the presence of smoke particles is detected by the smoke detector 200, a resistive load is applied to the signal receiving station 100 which generates an alert signal. The smoke detector 200 and the signal receiving station 100 are interconnected through the non-polarized wire cables 300. The smoke detecting system according to the present invention is characterized in that the detector circuitry 400 is branched at a middle of one of the non-polarized wire cables 300.

The detector circuitry 400 branched through T3 and T4 terminals at a middle of the non-polarized wire-cables senses a working current flowing through the non-polarized wire cables 300 and monitors the working status of the smoke detector 200, the signal receiving station 100 and the non-polarized wire cables 300. According to a specific embodiment of the present invention, the detector circuitry 400 comprises a current detecting terminal 401 branched at a middle of one of the non-polarized wire cables 300, a coupler 402 coupled to the signal detecting terminal 401 which senses a minute current flowing along the signal detecting terminal, and a display circuitry 403 coupled to the coupler 402 which comprises a transistor 403a amplifying the sensed current, a light emitting diode 403b indicating the working status of the smoke detector 200, the signal receiving station 100 and the non-polarized wire cables 300. At a normal condition, an internal circuitry (not shown) of the smoke detector 200 consumes a time-dependent current at a sine-wave. The time dependent current is detected by the detector circuitry 400, and the light emitting diode 403b blinks at a constant interval with the same frequency of the consumption current of the smoke detector 200. At an abnormal condition, the light emitting diode 403b will not blink. Consequently, the working status of the smoke detector 200, the signal receiving station 100 and the non-polarized wire cables 300 is monitored in a convenient and safe manner.

Further, according to more preferred embodiment of the present invention, the smoke detecting system further comprises a power supply circuitry 500 coupled to the detector circuitry 400 which supplies a power to the detector circuitry 400 and which comprises a power terminal 501, a constant voltage supply circuitry 502 and a light emitting diode 503 to indicate working status of the power supply circuitry 500. In this embodiment, working status of the power supply circuitry 500 can be easily monitored with the check of the blink of the light emitting diode 503.

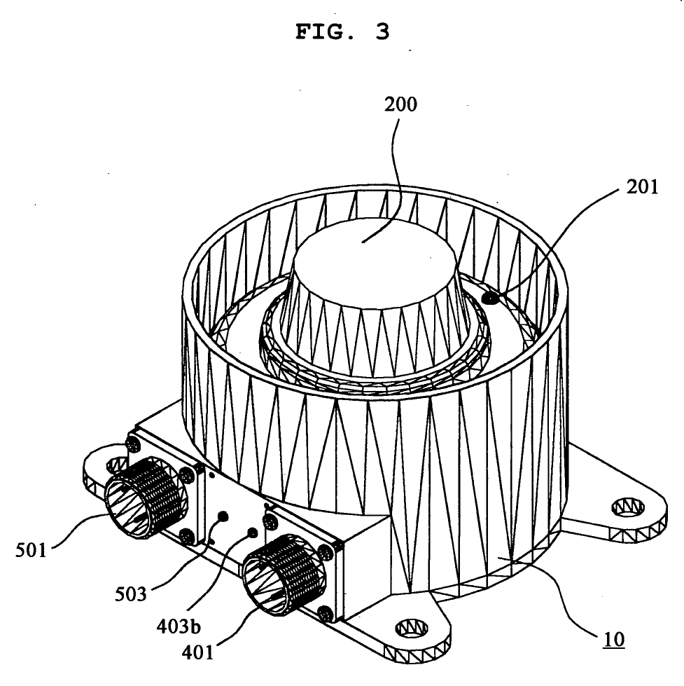

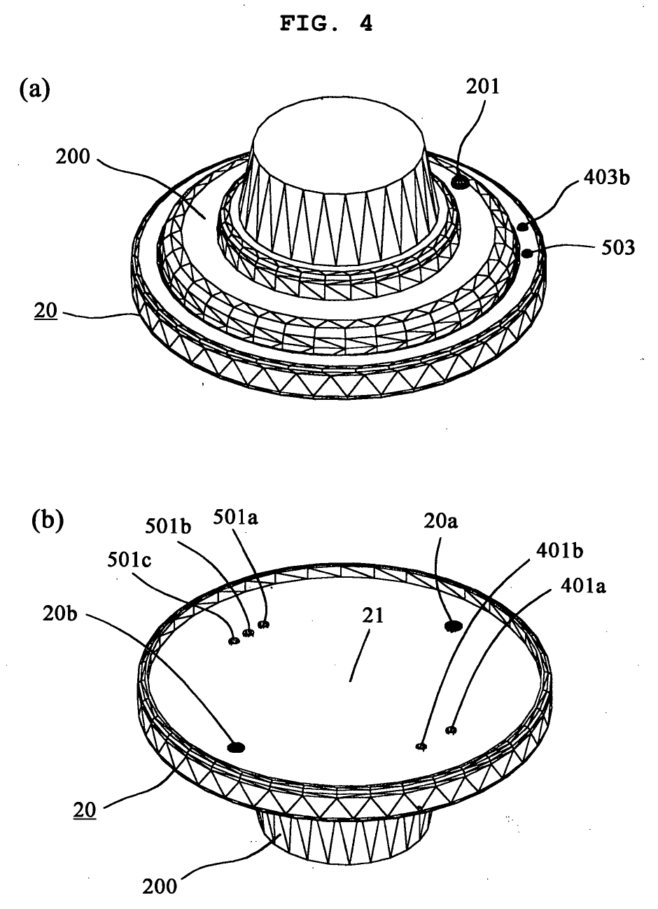

In a meanwhile, the detector circuitry 400 printed into a printing board can be disposed within a housing chamber of the smoke detecting system or internal space of a housing bracket located at a back of the smoke detector. FIGS. 3 and 4 are perspective views showing specific examples of the smoke detecting system in accordance with the present invention.

As shown in FIG. 3, a smoke detector 200 is disposed within a housing chamber 10. In the housing chamber 10, an internal empty space is formed below the smoke detector 200. In the internal empty space, the detector circuitry 400 printed into a printing board is housed. In the FIG. 3, the reference numeral 403b is a light emitting diode which indicates the working status of the smoke detector 200, the signal receiving station 100 and non-polarized wire cables 300. The reference numeral 503 is a light emitting diode which indicates working status of the power supply circuitry 500 which is also printed into the same printing board. The reference numeral 201 is a light emitting diode which indicates the presence of the smoke. When the smoke detector 200 detects the presence of smoke particles, a light emitting diode 201 of the smoke detector 200 blinks in order to indicate breaking out of a fire. The reference numerals 401 and 501 are, respectively, a current detecting terminal and a power terminal through which an alternative current power is supplied.

As shown in FIG. 4 in which FIGS. 4a and 4b are perspective top and bottom views, respectively, a housing bracket 20 may be formed below the smoke detector 200 in order to house the detector circuitry 400 printed into a printing board. The detector circuitry 400 printed into a printing board can be housed into an empty space 21 of the housing bracket 20. Unexplained reference numerals reference numerals 401a and 401b are current detecting terminals, reference numerals 501a, 501b and 501c are power terminals, and reference numerals 20a, and 20b are bolt-nut connection holes for the fixation of the bracket 20.

The smoke detecting system according to the present invention makes it possible to monitor the working status of the system through visual inspection. Further, in the smoke detecting system, there is no change to the internal circuitry of the smoke detector. The detection circuitry is branched out from one of the non-polarized wire cables. The advantageous effects of the present invention are as follows.

(1) The present invention can monitor the working status of the working status of a smoke detector, non-polarized wire cables and a signal receiving station through visual inspection of the display LED, without any artificial smoke spray into the smoke detector which causes deposition of foreign materials onto components of the smoke detector such as a signal receiving device and a signal generating device and which reduces the detection sensitivity.

(2) The present invention may utilize conventional smoke detectors because the system does not involve any change to the internal circuitry of the smoke detector. In addition, the present invention avoids the problems of complication of the internal circuitry, caused by the change to the internal circuitry of the smoke detector.

(3) The present invention has enhanced detection sensitivity, because the detection circuitry is not affected by an induced current produced within the internal circuitry of the smoke detector.

(4) The present invention may also check the connection status of the power supply introduced into the detection circuitry through visual inspection of the light emitting diode connected to a power supply circuitry.

1. A smoke detecting system, comprising:
a smoke detector which detects the presence of a smoke accompanied with a fire;
a signal receiving station which generates an alert signal;
non-polarized wire cables which physically connect the smoke detector to the signal receiving station; and
a detector circuitry which monitors the working status of the smoke detector, the signal receiving station and the non-polarized wire cables,
wherein the detector circuitry is branched at a middle of one of the non-polarized wire cables.

2. The smoke detecting system as set forth in claim 1, wherein the detector circuitry comprises a current detecting terminal branched at a middle of one of the non-polarized wire cables, a coupler coupled to the signal detecting terminal which senses a minute current flowing along the signal detecting terminal, and a display circuitry coupled to the coupler which comprises a transistor amplifying the sensed current and a light emitting diode indicating the working status of the smoke detector, the signal receiving station and the non-polarized wire cables.

3. The smoke detecting system as set forth in claim 1, further comprising a power supply circuitry coupled to the detector circuitry which supplies a power to the detector circuitry.

4. The smoke detecting system as set forth in claim 2, further comprising a power supply circuitry coupled to the detector circuitry which supplies a power to the detector circuitry.

5. The smoke detecting system as set forth in claim 3, wherein the power supply circuitry comprises a power terminal, a constant voltage supply circuitry and a light emitting diode to indicate working status of the power supply introduced to the detector circuitry.

6. The smoke detecting system as set forth in claim 4, wherein the power supply circuitry comprises a power terminal, a constant voltage supply circuitry and a light emitting diode to indicate working status of the power supply introduced to the detector circuitry.

7. The smoke detecting system as set forth in claim 1, wherein the detector circuitry is printed into a printing board and housed within a housing chamber of the smoke detecting system.

8. The smoke detecting system as set forth in claim 1, wherein the detector circuitry is printed into a printing board and housed inside a housing bracket located at a back of the smoke detector.

9. The smoke detecting system as set forth in claim 1, wherein the smoke detector comprises an internal circuitry which senses smoke particles and a light emitting diode which indicates breaking out of a fire.

10. The smoke detecting system as set forth in claim 2, wherein the smoke detector comprises an internal circuitry which senses smoke particles and a light emitting diode which indicates breaking out of a fire.

11. The smoke detecting system as set forth in claim 3, wherein the smoke detector comprises an internal circuitry which senses smoke particles and a light emitting diode which indicates breaking out of a fire.

12. The smoke detecting system as set forth in claim 4, wherein the smoke detector comprises an internal circuitry which senses smoke particles and a light emitting diode which indicates breaking out of a fire.
